(19) United States
(12) Patent Application Publication
(10) Pub. No.: US 2016/0375831 A1
(43) Pub. Date: Dec. 29, 2016

(54) HITCHING ASSIST WITH PAN/ZOOM AND VIRTUAL TOP-VIEW

(71) Applicant: GM GLOBAL TECHNOLOGY OPERATIONS LLC, DETROIT, MI (US)

(72) Inventors: JINSONG WANG, TROY, MI (US); WENDE ZHANG, TROY, MI (US); RYAN M. FRAKES, BLOOMFIELD HILLS, MI (US); MICHAEL A. WUERGLER, CLARKSTON, MI (US); ROBERT D. SIMS, III, MILFORD, MI (US); MOHANNAD MURAD, TROY, MI (US)

(21) Appl. No.: 15/178,156

(22) Filed: Jun. 9, 2016

Related U.S. Application Data
(60) Provisional application No. 62/183,539, filed on Jun. 23, 2015.

(51) Int. Cl. B60R 1/00; G06T 11/60; G06F 3/048; H04N 5/232

(52) U.S. Cl. CPC B60R 1/002; H04N 5/23216; H04N 5/23293; G06T 11/60; G06F 3/048; B60R 2300/607; B60R 2300/808; B60R 2300/305

(57) ABSTRACT

A system and method for providing visual assistance through a graphic overlay super-imposed on a back-up camera image displayed on, for example, a touch screen for assisting a vehicle operator when backing up a towing vehicle to align a hitch ball with a trailer drawbar coupler. The method includes providing camera modeling to correlate the camera image in camera coordinates to world coordinates, where the camera modeling provides a graphic overlay to include an alignment line having a height in the camera image that is determined by an estimated height of the trailer drawbar coupler. The touch screen also operates as a human-machine interface (HMI) that improves the visual assistance by providing one or more of image panning, image zoom, picture-in-picture (PIP), and a virtual top-down hitch-view.

### CROSS-REFERENCE TO RELATED APPLICATIONS

This application claims the benefit of the priority date of U.S. Provisional Patent Application Ser. No. 62/183,539, titled, Hitching Assist with Pan/Zoom and Virtual Top View, filed Jun. 23, 2015.

### BACKGROUND OF THE INVENTION

Field of the Invention

This invention relates generally to a system and method for providing visual assistance for aligning a tow hitch ball and a trailer drawbar coupler and, more particularly, to a system and method for providing visual assistance for aligning a tow hitch ball and a trailer drawbar coupler when backing up the towing vehicle to the towed vehicle that includes providing a raised alignment line that is part of a graphic overlay in a rear-view camera image, where the system employs a human-machine interface (HMI) that includes one or more of zoom, pan, picture-in-picture (PIP) and a virtual top-down hitch view.

Discussion of the Related Art

Some vehicles are equipped with a tow hitch that allows a trailer or other towed vehicle to be coupled thereto so that the towing vehicle can tow the trailer. Generally, the trailer hitch is mounted to a rear support structure of the towing vehicle proximate the vehicle's rear bumper, and includes a tow hitch ball having a certain diameter. The towed vehicle typically includes a trailer drawbar that extends from a front end of the towed vehicle. The trailer drawbar often includes a coupler in which the hitch ball is positioned to couple the hitch to the trailer drawbar. A securing mechanism within the coupler, such as a metal flap, is selectively positioned around the ball when it is inserted in the coupler to securely hold the drawbar to the hitch.

When the towed vehicle is detached from the towing vehicle, the trailer drawbar is generally supported on a height adjustable stand so that the coupler is positioned higher above the ground than the ball of the hitch. When the operator of the towing vehicle attaches the drawbar to the hitch, he will back up the towing vehicle to position the hitch ball just below the coupler. Once in this position, the drawbar is lowered onto the ball by lowering the stand.

Generally it takes a significant amount of experience and skill for the vehicle operator to accurately position the hitch ball below the drawbar coupler when backing up the towing vehicle to connect the towed vehicle to the towing vehicle. Regardless of the operator's skill and experience, it is nearly impossible to exactly position the hitch ball at the proper location. Therefore, the operator typically must use the trailer drawbar to manually move the towed vehicle in a right or left or front or back direction to provide the exact alignment. Because the towed vehicle may be large, heavy and cumbersome to move, this is sometimes a difficult task.

Modern vehicles often include one or more cameras that provide visual images to provide back-up assistance, provide images of the road as the vehicle is traveling for collision avoidance purposes, provide structure recognition, such as roadway signs, etc. Camera systems used for vehicle back-up assistance often employ visual overlay graphics that are super-imposed or over-laid on the camera image to provide vehicle back-up steering guidance. For those applications where graphics are over-laid on the camera images, it is critical to accurately calibrate the position and orientation of the camera with respect to the vehicle. Camera calibration typically involves determining a set of parameters that relate camera image coordinates to vehicle coordinates and vice versa. Some camera parameters, such as camera focal length, optical center, etc., are stable, while other parameters, such as camera orientation and position, are not. For example, the height of the camera depends on the load of the vehicle, which will change from time to time. This change can cause overlaid graphics of vehicle trajectory on the camera image to be inaccurate.

U.S. patent application Ser. No. 14/476,345 titled, Smart Tow, filed Sep. 3, 2014, US Patent Application Publication No. 2015/0115571 published Apr. 30, 2015, assigned to the assignee of this application, discloses a system and method for providing visual assistance through a graphic overlay super-imposed on a back-up camera image for assisting a vehicle operator when backing up a vehicle to align a tow hitch ball to a trailer drawbar. The method includes providing camera modeling to correlate the camera image in vehicle coordinates to world coordinates, where the camera modeling provides the graphic overlay to include a tow line having a height in the camera image that is determined by an estimated height of the trailer drawbar. The method also includes providing vehicle dynamic modeling for identifying the motion of the vehicle as it moves around a center of rotation. The method then predicts the path of the vehicle as it is being steered including calculating the center of rotation.

The above described system in the '345 application is effective in providing visual assistance to the vehicle operator when aligning a hitch ball to a trailer drawbar coupler. However, additional elements can be provided in combination with this visual assistance to improve the hitch ball aligning assistance.

### SUMMARY OF THE INVENTION

The present invention discloses and describes a system and method for providing visual assistance through a graphic overlay super-imposed on a back-up camera image displayed on, for example, a touch screen for assisting a vehicle operator when backing up a towing vehicle to align a hitch ball with a trailer drawbar coupler. The method includes providing camera modeling to correlate the camera image in camera coordinates to world coordinates, where the camera modeling provides a graphic overlay to include an alignment line having a height in the camera image that is determined by an estimated height of the trailer drawbar coupler. The touch screen also operates as a human-machine interface (HMI) that improves the visual assistance by providing one or more of image panning, image zoom, picture-in-picture (PIP), and a virtual top-down hitch-view.

Additional features of the present invention will become apparent from the following description and appended claims, taken in conjunction with the accompanying drawings.

### BRIEF DESCRIPTION OF THE DRAWINGS

FIG. 1 is an illustration of a rear-view camera image showing a vehicle including a tow hitch ball backing up relative to a trailer including a trailer drawbar with a coupler, and showing an HMI for assisting in the hitch ball alignment;

FIG. 2 is an illustration of the camera image shown in FIG. 1 where the vehicle is closer to the trailer;

FIG. 3 is an illustration of a virtual top-down hitch-view of the image shown in FIG. 2; and

FIG. 4 is a flow chart diagram showing operation of the visual tow assist method.

### DETAILED DESCRIPTION OF THE EMBODIMENTS

The following discussion of the embodiments of the invention directed to a system and method including HMI components for providing visual assistance for a driver driving a towing vehicle to align a tow hitch ball to a trailer drawbar using a graphic overlay on a rear-view camera image is merely exemplary in nature, and is in no way intended to limit the invention or its applications or uses. For example, as discussed, the system and method has particular application for positioning a vehicle so that a tow hitch ball aligns with a trailer drawbar coupler. However, as will be appreciated by those skilled in the art, the system and method may have applications for other mobile platforms, such as on trains, machines, tractors, boats, recreational vehicles, etc.

The present invention proposes a system and method for providing back-up visual assistance by employing a graphics overlay super-imposed on a rear-view camera image to assist a vehicle operator when aligning a tow hitch ball to a trailer drawbar coupler, where the method employs HMI components including image pan, image zoom, PIP, and a virtual top-down hitch view.

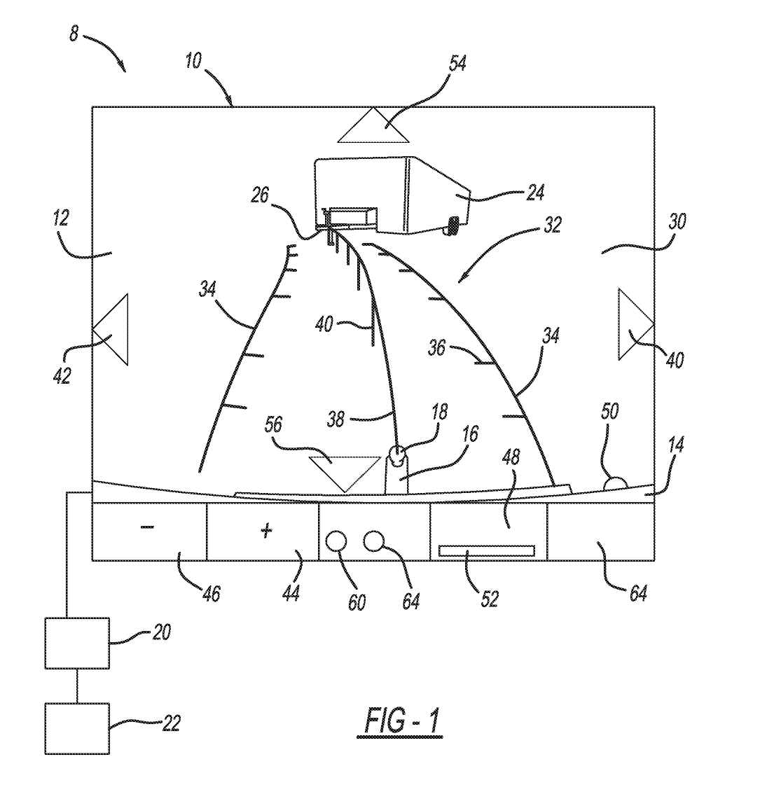

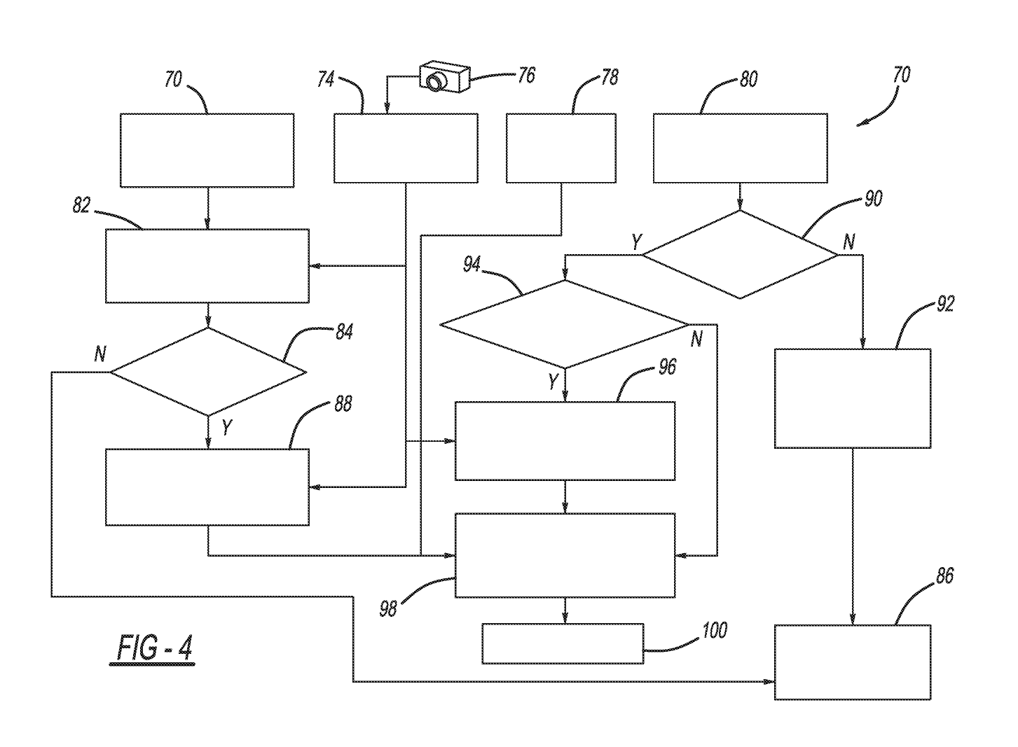

FIG. 1 is an illustration 8 including a vehicle touch screen 10 displaying a rear-view camera image 12 from a rear-view camera (see FIG. 4) mounted to a rear of a vehicle 14 shown in the image 12, where the vehicle 14 includes a tow hitch 16 having a tow hitch ball 18 extending therefrom. In one embodiment, the screen 10 is part of the center stack control area of the vehicle 14. A back-up assistance system 20 is shown generally on the vehicle 14 and includes all of the cameras, camera image processors, algorithms, GPS, map databases, wireless communications, controllers, CAN buses, etc. required for the invention as discussed below. Box 22 represents a display device on the vehicle 14 that the image 12 can be displayed on to allow the vehicle operator to watch the image 12. The image 12 shows a trailer 24 behind the vehicle 14 and including a trailer drawbar 26 having a coupler 28 positioned some distance above the ground 30 and higher than the tow hitch ball 18. FIG. 2 is another view of the touch screen 10 where the rear-view image 12 shows the vehicle 14 closer to the trailer 24.

As will be discussed in detail below, the back-up assistance system 20 provides visual feedback and hitch alignment assistance through a graphic overlay 32 on the image 12, where the graphic overlay 32 includes side bars 34 and cross bars 36 super-imposed on the ground 30 in the image 12. Additionally, the graphic overlay 32 includes a trailer hitch alignment line 38 that is overlaid in the image 12 some distance above the ground 30 that is based on an estimate of the height of the trailer drawbar 26 off of the ground 30. Vertical bars 40 connected to the trailer hitch alignment line 38 show that the trailer hitch alignment line 38 is raised off of the ground 30. It is noted that the vertical bars 40, the side bars 34 and the cross bars 36 are merely for convenience and are not necessary to be displayed in the image 12 for the functionality of the system as described herein. As the vehicle operator turns the vehicle steering wheel, the overlay 32 rotates and moves relative to the vehicle 14 to show the current back-up path of the vehicle 14 at any one point in time. The basic procedures and processes necessary to super-impose the graphic overlay 32 on the camera image 12 are well known to those skilled in the art.

In one embodiment, the back-up assistance system 20 employs a three step process, where the first step includes camera modeling to model the graphic overlay 32 provided in camera coordinates to vehicle coordinates on the ground 30 and on an estimate of the height of the trailer drawbar 26 off of the ground 30, and to properly center the overlay 32 in the image 12, where the camera may not be centered at the rear of the vehicle 14. The camera model may also provide image de-warping to flatten the image plane of the fish eye image. Camera modeling for this purpose is well known to those skilled in the art and many algorithms performing such modeling are known. One suitable example can be found in U.S. patent application Ser. No. 13/843,978, titled, Wide FOV Camera Image Calibration and De-warping, filed Mar. 15, 2013, US Patent Application Publication No. 2014/0085409 published Mar. 27, 2014, assigned to the assignee of this application. Camera modeling of this type typically involves determining a set of parameters that relate camera image coordinates to vehicle coordinates and vice versa. Some camera parameters, such as camera focal length, optical center, etc., are stable, while other parameters, such as camera orientation and position, are not. For example, the height of the camera depends on the load of the vehicle, which will change from time to time. This change can cause the graphic overlay 32 of vehicle trajectory on the camera image 12 to be inaccurate.

The next step in the process includes performing vehicle dynamic modeling to model the dynamics or motion of the vehicle 14 so that the vehicle path when the vehicle 14 is backing up can be predicted and the overlay 32 can be accurately adjusted as the vehicle operator steers the vehicle 14 during the back-up maneuver. By employing the vehicle dynamic model, the algorithm can calculate how the vehicle 14 turns in response to the vehicle operator steering the vehicle 14 during the back-up maneuver. The '345 application referred to above provides a detailed discussion as to how the dynamic modeling is performed. Once the vehicle 14 is modeled and the coordinate systems are correlated, the next step in the process is to predict the path of the vehicle 14 in world coordinates as it is backing up toward the trailer 24. The '345 application also provides, detailed discussion as to how this step is performed.

To further enhance the visual assistance as described herein, the present invention proposes employing HMI components that use vehicle operator inputs through various techniques, such as a touch screen with finger or stylus pen input, physical push buttons or knobs, gesture recognition, etc., to allow the vehicle operator to change the rear-view image 12 to improve the visual back-up assistance. For example, a driver monitoring system (DMS) including a camera internal to the passenger compartment of the vehicle 14 may provide images of the vehicle operator's gestures that can be used as the interface. As will be discussed below, the HMI components include image panning, image zoom, PIP and a top-down hitch-view, for example, that can be employed to enhance a region of interest in the image 12, such as shifting the image and zooming in to enlarge the trailer drawbar/coupler region relative to the hitch guide alignment line 38. As will be discussed, the HMI components allow the vehicle operator or a sensing system on the vehicle 14 to toggle between the regular rear-view and a synthesized virtual top-down hitch-view, for example, when the vehicle 14 is getting close to the trailer 24, where the system 20 will automatically switch to the virtual top-down hitch-view either manually by user input or automatically by sensor detection, such as ultrasonic sensor, vision sensor, etc.

These HMI components are provided as touch screen inputs on the screen 10 in this non-limiting example. For example, the screen 10 includes right and left pan arrows 40 and 42 and up and down pan arrow 54 and 56 (only shown in FIG. 1 for clarity) that allow the image 12 to be shifted to the right and left and up and down in a virtual manner through suitable software algorithms within some rotational degree range by pressing the arrows 40, 42, 54 and 56. The HMI components also include plus and minus zoom buttons 44 and 46 that allow the image 12 to be zoomed in and zoomed out in a virtual manner through suitable software algorithms to enlarge a particular area in the image 12. For example, when the trailer 24 is far away from the vehicle 14, the coupler 28 is not clearly visible in the image 12, and thus, the zoom in feature may be desirable. The pan and zoom features can be used in combination to isolate and enlarge any area in the image 12.

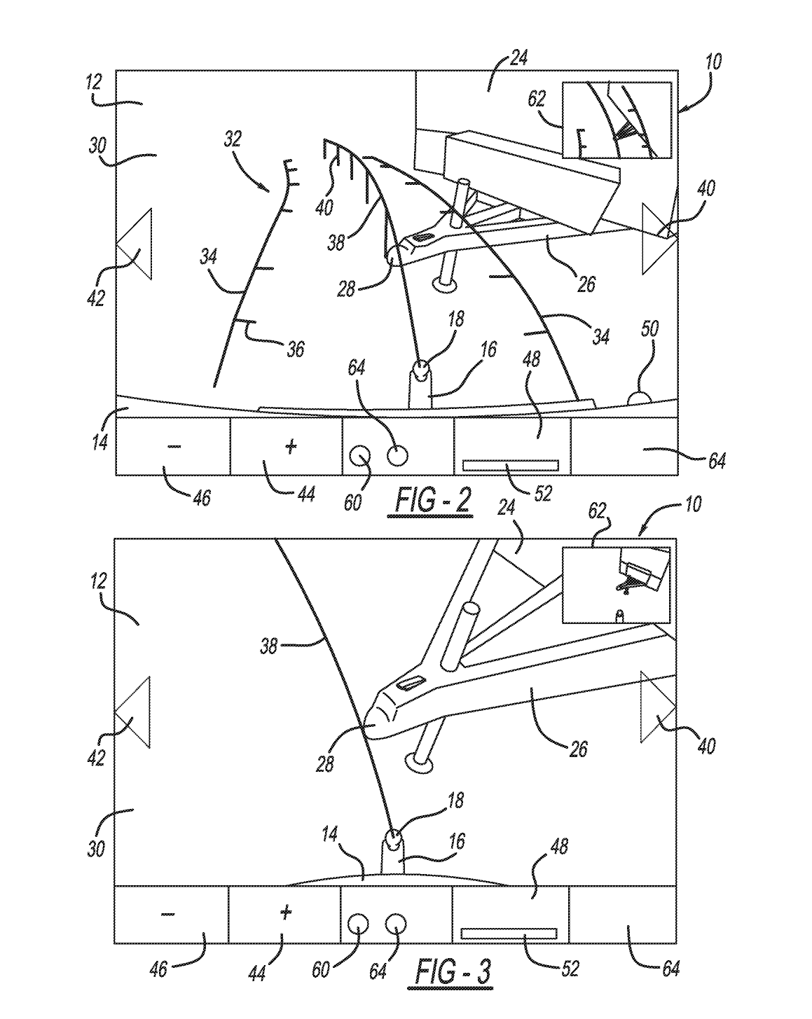

The HMI components also include a hitch-view button 48 that causes the image 12 to change from a regular view to a top-down hitch-view. FIG. 3 is an illustration of the screen 10 including the image 12 as shown in FIG. 2 in the top-down hitch-view, where the vehicle 14 and the trailer 24 are at the same location. Such a virtual top-down hitch-view is possible because the orientation of the rear-view camera is typically pitched downward, where calibration is required to provide a rear-view image oriented relative to the vehicle 14. The system 20 can cause the top-down hitch-view to be automatically provided once the hitch ball 18 gets within a certain range of the hitch coupler 28, as detected by, for example, ultrasonic sensors 50 on the vehicle 14. A bar 52 on the hitch view button 48 provides an indication by changing color when the image 12 is in the top-down hitch-view.

The HMI components also include a PIP button 60 that when pressed causes a small PIP image 62 to be provided in a corner of the image 12, which can be the virtual top-down hitch-view. A toggle button 64 is associated with the PIP button 60 so that when the toggle button 64 is pressed, the main image 12 and the PIP image 62 are switched. FIG. 2 shows the main image 12 as the normal view and the PIP image 62 as the top-down hitch-view and FIG. 3 shows the main image 12 as the top-down hitch-view and the PIP image 62 as the normal view. The PIP button 60 can change colors when it is pressed to provide an indication to the user that the PIP image 62 is being provided. The HMI components also include a hitch mode exit button 64 that can take the system 20 out of the hitch mode assist, for example, by removing the alignment line 38.

It is noted that in alternate embodiments, all of the pan, zoom, PIP and top-down hitch-view may not necessarily be employed, where any combination of these features can be provided. For example, one alternative may employ the normal view and the top-down hitch-view with a pre-defined zoom and pan position without the ability to provide pan, zoom and PIP.

FIG. 4 is a flow chart diagram 70 showing a process for providing the visual back-up assistance as discussed above. Vehicle information is obtained at box 72, such as vehicle steering angle, that is needed to generate the graphic overlay 32. Camera calibration is provided at box 74 for camera images provided by a rear-view camera 76. HMI user interface signals from the HMI components are provided at box 78 and camera video stream is provided at box 80. The algorithm uses the vehicle information from the box 72 and the camera calibration data from the box 74 to generate the graphic overlay 32 at box 82 as discussed above. The algorithm then determines whether the hitch assist mode has been activated to provide the visual assistance at decision diamond 84, and if not, proceeds to a display mode box 86 to display the graphic overlay 32 without the alignment line 38. If the hitch assist mode has been activated at the decision diamond 84, then the algorithm generates the alignment line 38 at box 88 using the camera calibration information from the box 74 and the vehicle information from the box 72. The algorithm also determines whether the vehicle 14 is in the hitch assist mode at decision diamond 90, and if not, uses the camera data to generate the graphic overlay 32 at box 92. If the hitch assist mode has been activated at the decision diamond 90, then the algorithm determines whether the camera data should be used to provide a top-down hitch-view and picture-in-picture at decision diamond 94, and if so, generates the top-down hitch-view at box 96 using the camera calibration information from the box 74. If the top-down hitch-view is not requested at the decision diamond 94 or the top-down hitch-view is generated at the box 96 or the alignment line is generated at the box 88, the algorithm draws the alignment line 38 at box 98 using the HMI user interface information from the box 78 and the alignment line from the box 88. The algorithm then proceeds to the hitch display mode at box 100.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing assistance for aligning a hitch tow ball on a towing vehicle with a drawbar on a towed vehicle during a hitching process, said method comprising:
providing camera modeling to correlate a main camera image from a camera at a rear of the towing vehicle in camera coordinates to vehicle coordinates, said camera modeling providing a graphic overlay super-imposed on the main camera image and provides visual steering assistance, said graphic overlay including an alignment line having a height in the main camera image that is determined by an estimated height of the drawbar;
providing vehicle dynamic modeling for identifying the motion of the towing vehicle as the towing vehicle moves around a center of rotation;
providing human-machine interface (HMI) components for changing the main camera image; and
predicting the path of the towing vehicle as it is being steered including calculating the center of rotation.

2. The method according to claim 1 wherein providing HMI components includes providing a picture-in-picture (PIP) image in the main camera image.

3. The method according to claim 2 wherein providing HMI components includes toggling between the main camera image and the PIP image.

4. The method according to claim 1 wherein providing HMI components includes providing a virtual top-down hitch-view.

5. The method according to claim 4 wherein providing a top-down hitch-view includes providing a top-down hitch-view that is synthesized from the main camera image using camera modeling and camera calibration information.

6. The method according to claim 4 wherein the top-down hitch-view is activated manually by vehicle operator input.

7. The method according to claim 4 wherein the top-down hitch-view is automatically provided when the towing vehicle is within a predetermined range of the towed vehicle.

8. The method according to claim 7 wherein automatically providing the top-down hitch-view includes providing the hitch-view in response to a signal from an ultrasonic sensor detecting the towed vehicle when the towed vehicle is a certain range of the towing vehicle.

9. The method according to claim 1 wherein providing HMI components includes providing zoom in and zoom out of the main camera image.

10. The method according to claim 1 wherein the HMI components include panning the main camera image.

11. The method according to claim 1 wherein providing HMI components including providing HMI components through a touch screen.

12. The method according to claim 1 wherein providing HMI components includes activating the HMI components through one or more of a touch screen, stylus pen, physical push buttons or gesture recognition.

13. A method for providing assistance for aligning a hitch tow ball on a towing vehicle with a drawbar on a towed vehicle during a hitching process, said method comprising:
providing camera modeling to correlate a main camera image from a camera at a rear of the towing vehicle in camera coordinates to vehicle coordinates, said camera modeling providing a graphic overlay super-imposed on the main camera image and provides visual steering assistance, said graphic overlay including an alignment line having a height in the main camera image that is determined by an estimated height of the drawbar;
providing vehicle dynamic modeling for identifying the motion of the towing vehicle as the towing vehicle moves around a center of rotation;
providing human-machine interface (HMI) components for changing the main camera image, wherein providing HMI components includes providing a picture-in-picture (PIP) image in the main camera image, toggling between the main camera image and the PIP image, providing a virtual top-down hitch-view that is synthesized from the main camera image using camera modeling and camera calibration information, providing zoom in and zoom out of the main camera image, and panning the main camera image; and
predicting the path of the towing vehicle as it is being steered including calculating the center of rotation.

14. The method according to claim 13 wherein the top-down hitch-view is activated manually by vehicle operator input.

15. The method according to claim 13 wherein the top-down hitch-view is automatically provided when the towing vehicle is within a predetermined range of the towed vehicle.

16. The method according to claim 15 wherein automatically providing the top-down hitch-view includes providing the hitch-view in response to a signal from an ultrasonic sensor detecting the towed vehicle when the towed vehicle is a certain range of the towing vehicle.

17. The method according to claim 13 wherein providing HMI components includes activating the HMI components through one or more of a touch screen, stylus pen, physical push buttons or gesture recognition.

18. A system for providing assistance for aligning a hitch tow ball on a towing vehicle with a drawbar on a towed vehicle during a hitching process, said system comprising:
means for providing camera modeling to correlate a main camera image from a camera at a rear of the towing vehicle in camera coordinates to vehicle coordinates, said camera modeling providing a graphic overlay super-imposed on the main camera image and provides visual steering assistance, said graphic overlay including an alignment line having a height in the main camera image that is determined by an estimated height of the drawbar;
means for providing vehicle dynamic modeling for identifying the motion of the towing vehicle as the towing vehicle moves around a center of rotation;
means for providing human-machine interface (HMI) components for changing the main camera image; and
means for predicting the path of the towing vehicle as it is being steered including calculating the center of rotation.

19. The system according to claim 18 wherein the means for providing HMI components provides a picture-in-picture (PIP) image in the main camera image, toggles between the main camera image and the PIP image, provides a virtual top-down hitch-view that is synthesized from the main camera image using camera modeling and camera calibration information, provides zoom in and zoom out of the main camera image, and provides panning the main camera image.

20. The system according to claim 18 wherein the means for providing HMI components activates the HMI components through one or more of a touch screen, stylus pen, physical push buttons or gesture recognition.
